(19) United States
(12) Patent Application Publication
(10) Pub. No.: US 2012/0211418 A1
(43) Pub. Date: Aug. 23, 2012

(54) Slurry Concentration System and Method

(75) Inventors: Shih-Ming Wang, Hsin-Chu (TW); Wen-Cheng Chou, Hsin-Chu (TW)

(73) Assignee: Taiwan Semiconductor Manufacturing Company, Ltd., Hsin-Chu (TW)

(21) Appl. No.: 13/031,019

(22) Filed: Feb. 18, 2011

(51) Int. Cl. B01D 61/14; B01D 65/02; B01D 63/00

(52) U.S. Cl. 210/636; 210/108

(57) ABSTRACT

A system and method for concentrating a slurry is disclosed. A preferred embodiment comprises a filter that is used to filter a slurry into a concentrate and a permeate. A portion of the permeate is used in a backflow operation of the filter once a pressure differential of 0.8 bar is obtained from the filter inlet to the permeate outlet of the filter.

### TECHNICAL FIELD

Present embodiments relate generally to a system and method for semiconductor processing and, more particularly, to a system and method for concentrating chemical mechanical polish waste slurry.

### BACKGROUND

Generally, when a chemical mechanical polishing (CMP) process is utilized to remove and planarize various layers of a semiconductor device, the CMP process will utilize a CMP slurry which contains various chemical etchant and abrasive components. These components work to both chemically and mechanically remove portions of the semiconductor device.

However, once the CMP slurry has been used, it must be disposed. One method of disposal includes sending the entire waste CMP slurry to a waste treatment facility. However, by essentially throwing away the waste CMP slurry in this fashion, any remaining value that may be found in the waste CMP slurry, such as the abrasive or unutilized chemical components, is lost.

Another potential method is to attempt to recycle the waste CMP slurry through such methods as sending the waste CMP slurry off site to a recycler in order to recover the abrasives and chemical components. In such a process, in order to lower costs, components that don't need to be recycled, such as water, may be removed from the waste CMP slurry, thereby concentrating the waste CMP slurry before it is shipped off site. In such a process, the waste CMP slurry may be passed through a filter to both recover the abrasives as well as to remove excess water from the waste CMP slurry. A portion of the removed water may be used to backwash the filter and recover the previously captured abrasives to form a CMP slurry with a concentrated abrasive content. This CMP slurry with the concentrated abrasive content may then be shipped off-site in order to recover the chemical components. However, while this filtering and concentrating can help to reduce the cost of shipping material off-site, the process is still not sufficient to meet the high-throughput, low cost demands of today's semiconductor manufacturing.

### BRIEF DESCRIPTION OF THE DRAWINGS

For a more complete understanding of present embodiments, and the advantages thereof, reference is now made to the following descriptions taken in conjunction with the accompanying drawings, in which:

FIG. 1 illustrates a process flow diagram of a chemical mechanical polishing slurry in accordance with an embodiment;

FIG. 2 illustrates a filtering process of the waste CMP slurry in accordance with an embodiment;

FIG. 3 illustrates a cleansing operation of the waste CMP slurry in accordance with an embodiment;

FIG. 4 illustrates a plurality of filters set up in a parallel fashion in accordance with an embodiment;

FIG. 5 illustrates the particle size results of concentrating the CMP waste slurry in accordance with an embodiment; and

FIG. 6 illustrates the abrasive content as a function of trigger pressure in accordance with an embodiment.

Corresponding numerals and symbols in the different figures generally refer to corresponding parts unless otherwise indicated. The figures are drawn to clearly illustrate the relevant aspects of the preferred embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present embodiments provide many applicable inventive concepts that can be embodied in a wide variety of specific contexts. The specific embodiments discussed are merely illustrative of specific ways to make and use the embodiments, and do not limit the scope of the embodiments.

Embodiments will be described in a specific context, namely a waste slurry concentration unit. Embodiments may also be applied, however, to other concentration units.

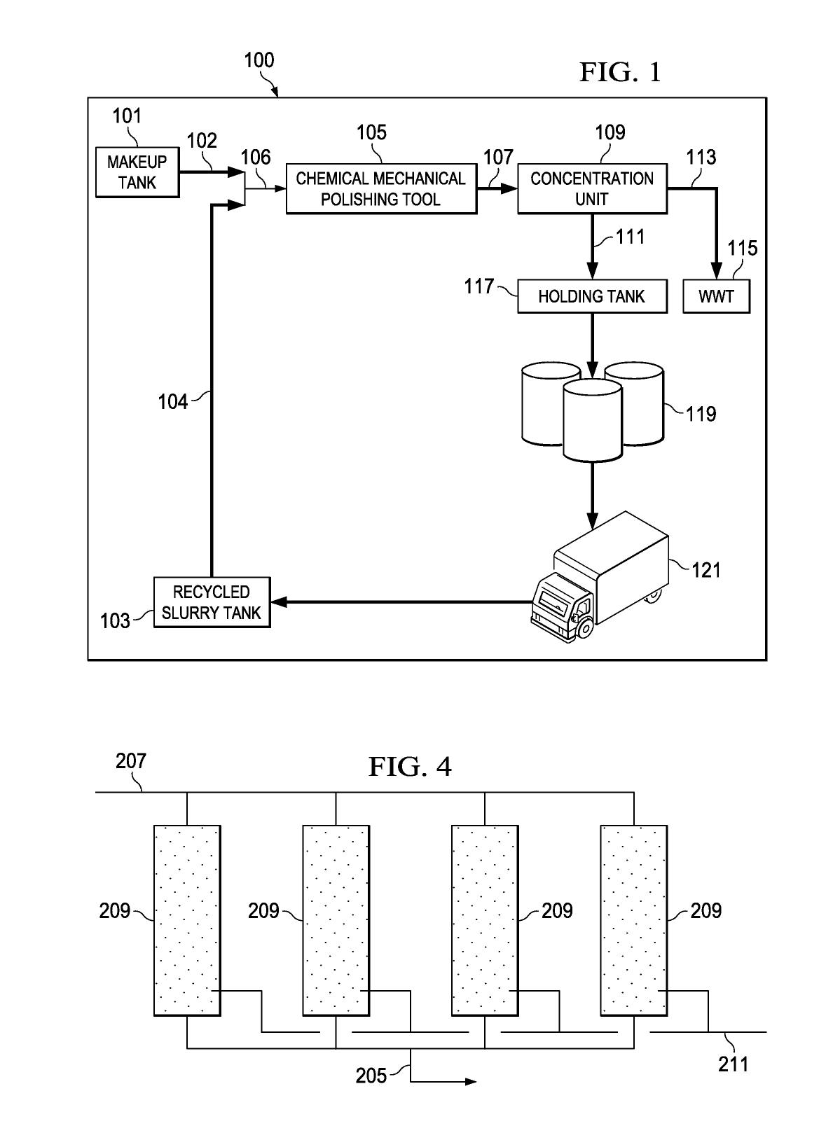

With reference now to FIG. 1, there is shown a chemical mechanical polishing (CMP) slurry system 100. In the CMP slurry system 100 makeup CMP slurry 102 may be initially added to the CMP slurry system 100 by placing it into a makeup tank 101. The makeup CMP slurry 102 may be added in order to account for components that were not able to be completely recycled or were otherwise lost during the CMP process or CMP waste slurry recycling process.

In an embodiment, the makeup CMP slurry 102 may have a combination of chemical reactants and abrasives in order to help remove and planarize layers of a semiconductor structure (not shown). For example, the makeup CMP slurry 102 may contain chemical reactants (e.g., potassium hydroxide (KOH)) and other chemicals such as mineral acids, organic acids, strong bases, mineral salts, organic salts, pH buffers, oxidizing agents, organic and inorganic peroxides, corrosion inhibitors, chelating agents, liquid polymers, surfactants, stabilizers, solvents (e.g., water), combinations of these, or the like, depending on the precise makeup of the layer which it is desired to be removed and planarized. Additionally, the makeup CMP slurry 102 may also contain an abrasive, such as silica (SiO₂), alumina, ceria, titanium oxide, zirconia, combinations of these, or the like, in a concentration of between about 10% by volume and about 25% by volume, such as about 25% by volume. In an embodiment, the abrasives may have a particle size of between about 20 nm and about 1000 nm, such as about 343 nm.

The makeup CMP slurry 102 may be mixed with a recycled slurry 104 (discussed further below) into a final slurry stream 106, which may then be sent to be used by a CMP tool 105. The final slurry stream 106 may be made up of about 10% (by volume) makeup CMP slurry 102 and about 90% (by volume) recycled slurry 104. For example, in an embodiment in which the final slurry stream 106 has a flow rate of about 300 cubic meters per hour (CMH), the final slurry stream 106 may be may be a mixture of about 30 CMH of makeup CMP slurry 102 (10%) and 270 CMH of recycled slurry 104 (90%). This final slurry stream 106 may then be sent to the CMP tool 105.

In the CMP tool 105 the final slurry stream 106 may be applied to a semiconductor structure (not shown), where the chemical reactants within the final slurry stream 106 work as an etchant to either remove or soften the exposed surfaces of the semiconductor structure. Additionally, an abrasive platen may, e.g., be rotatably applied to the semiconductor structure and used along with the abrasives within the final slurry stream 106 in order to abrade the semiconductor structure. This combination of chemical reactants and application of abrasives (in both the platen as well as the abrasives in the final slurry stream 106) work to remove and planarize the exposed semiconductor structure to a desired level.

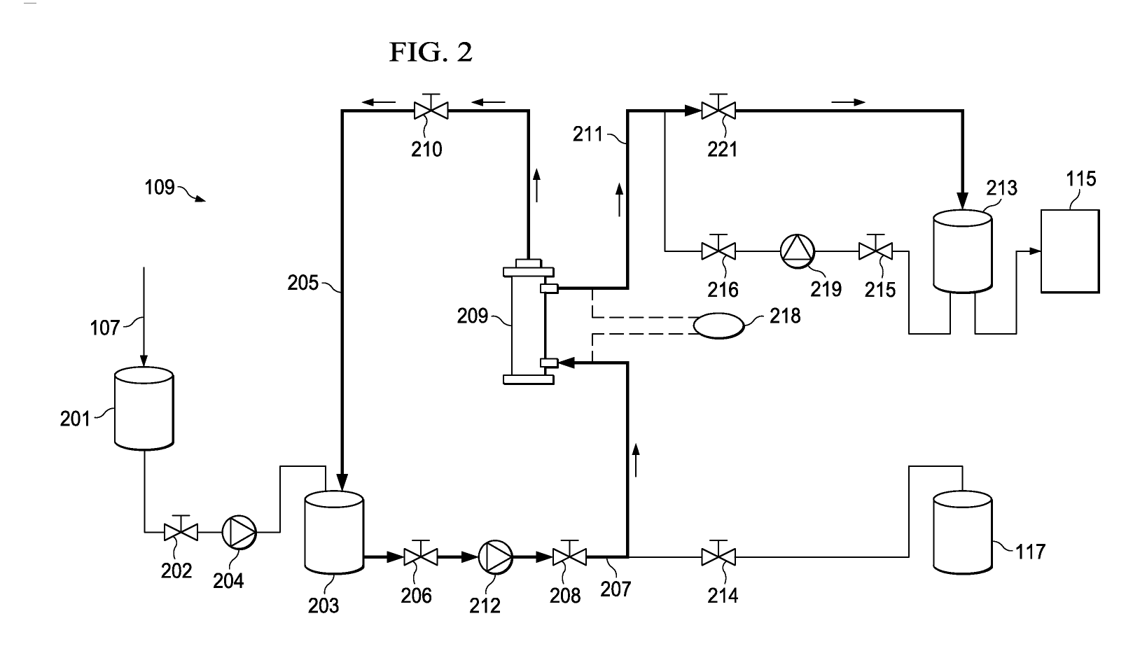

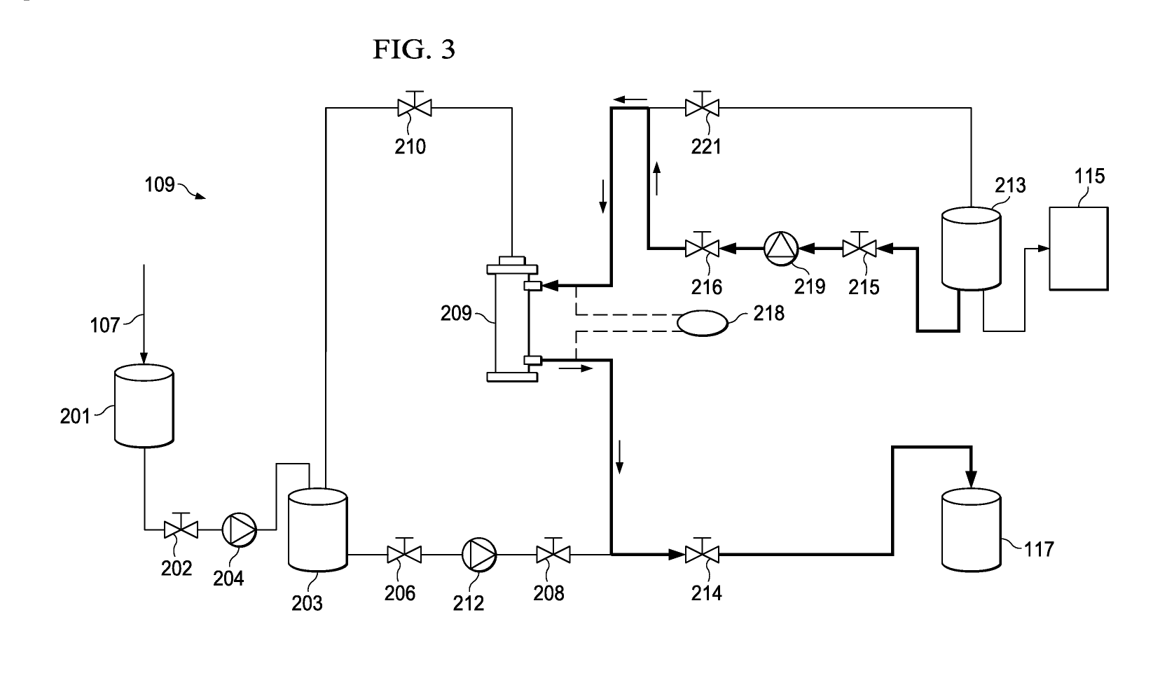

During the CMP process, CMP waste slurry 107 may be removed so that fresh final slurry stream 106 may be added to keep the CMP process running at optimal conditions. However, instead of sending all of the CMP waste slurry 107 to a waste treatment facility, and essentially waste any remaining value within the CMP waste slurry 107, in an embodiment the CMP waste slurry 107 may be directed towards a concentration unit 109 (described in further detail below with respect to FIGS. 2-3). The concentration unit 109 may be used to both separate out permeate (e.g., water) 113 from the CMP waste slurry 107 and also to concentrate the CMP waste slurry 107.

By removing the permeate 113 from the CMP waste slurry 107, a concentrated CMP waste slurry 111 may be formed, which may be sent to a holding tank 117 for storage. From the holding tank 117, the concentrated CMP waste slurry 111 may be placed into storage drums 119 and shipped to a treatment facility located as either on-site facility or an off-site facility. The treatment facility, for a price usually measured by the amount of slurry sent, may process the concentrated CMP waste slurry 111 and then return the concentrated CMP waste slurry 111 as recycled slurry 104. The recycled slurry 104 may be placed into the recycled slurry tank 103 for eventual mixture with the makeup CMP slurry 102, thereby completing a recycle process loop.

In FIG. 1 this entire process of shipping the concentrated CMP waste slurry 111 to a recycling facility is represented by the illustrated truck 121. However, as one of ordinary skill in the art will recognize, the placement of concentrated CMP waste slurry 111 into drums for transport by truck to an off-site facility is but one suitable method of recycling the concentrated CMP waste slurry 111. Any other suitable method, such as transporting the concentrated CMP waste slurry 111 through a pipeline to an on-site recycling facility, or using a tanker truck to transport the concentrated CMP waste slurry 111, may alternatively be used, and all such suitable methods of transport are fully intended to be included within the scope of the present embodiments.

The permeate 113 extracted from the CMP waste slurry 107 may be sent to a waste treatment facility, such as a wastewater treatment facility 115. The wastewater treatment facility 115 may receive the permeate 113 (along with other wastewater from other areas of the semiconductor manufacturing process) and treat the water to acceptable standards prior to either reusing the permeate 113 or else releasing the permeate 133 and other wastewater to the environment.

FIG. 2 illustrates in further detail an embodiment of the concentration unit 109 of the CMP slurry system 100 during a filtering operation, in which the direction of flow for various streams are highlighted by the arrows. As illustrated the CMP waste slurry 107 enters the concentration unit 109 and is initially stored in a first storage tank 201. The CMP waste slurry 107 at this stage may have an initial abrasive concentration of between about 0.3% by volume and about 0.6% by volume, such as about 0.5% by volume.

The first storage tank 201 may be used to store and regulate the flow of the CMP waste slurry 107 in the concentration unit 109. As such, the first storage tank 201 may be an appropriate size to accommodate both the incoming CMP waste slurry 107 along with the operating capacity of the concentration unit 109 (including potential down time associated with maintenance or other activities) without overflowing the first storage tank 201. For example, for an incoming flow rate of the incoming CMP waste slurry 107 of between about 100 CMH and about 400 CMH, such as about 300 CMH, the first storage tank may be between about 100 cubic meters and about 200 cubic meters, such as about 150 cubic meters.

When the concentration unit 109 is ready to process the CMP waste slurry 107, a first valve 202 may be opened and a first pump 204 may be turned on to pump the CMP waste slurry 107 into a second storage tank 203. In the second storage tank 203, the CMP waste slurry 107 may be mixed with a recycled stream of concentrated CMP slurry 205 (described further below) from a filter 209. This mixing forms a filter-ready CMP waste slurry 207, and may occur through a passive diffusion of the streams into each other or, alternatively, may be assisted with a stirrer or other active mixing process (not shown in FIG. 2).

The concentrated CMP slurry 205 may be a recycle stream from the filter 209, and, because it has already progressed through a concentration process once, may have a higher concentration of abrasives than the CMP waste slurry 107. As such, the mixing of the concentrated CMP slurry 205 and the CMP waste slurry 107 will cause the filter-ready CMP waste slurry 207 to have a higher concentration of abrasives than the CMP waste slurry 107. For example, the concentrated CMP slurry 205 may have an abrasive concentration of between about 150 ppm and about 300 ppm, such as about 250 ppm, at a flow rate of between about 30 CMH and about 60 CMH, such as about 50 CMH. Additionally, in this embodiment the filter-ready CMP waste slurry 207 may have a concentration of abrasives between about 4% and about 6%, such as about 5%, at a flow rate of between about 180 CMH and about 390 CMH, such as about 300 CMH.

Additionally, similar to the first storage tank 201, the second storage tank 203 may be appropriately sized in order to accommodate the flow of both the CMP waste slurry 107 from the first storage tank 201 and the concentrated CMP slurry 205. In an embodiment where the flow rate of CMP waste slurry 107 from the first storage tank 201 is between about 180 CMH and about 390 CMH, such as about 300 CMH, and the flow rate from the concentrated CMP slurry 205 is between about 30 CMH and about 60 CMH, such as about 50 CMH, the size of the second storage tank 203 may be between about 100 cubic meters and about 200 cubic meters, such as about 150 cubic meter.

Optionally, the pH of the filter-ready CMP waste slurry 207 stored in the second storage tank 203 may be controlled to be between about 7 and about 10, such as about 9.5. If the filter-ready CMP waste slurry 207 is outside of this range (as determined from testing), then pH adjusters, such as potassium hydroxide, hydrochloric acid, sulfuric acid, phosphoric acid, sodium hydroxide, ammonium hydroxide, combinations of these, or the like, may be utilized to bring the filter-ready CMP waste slurry 207 back into the appropriate range. For example, the filter-ready CMP waste slurry 207 in the second storage tank 203 may be analyzed and the pH adjusters may be added as needed to increase or decrease the pH of the filter-ready CMP waste slurry 207 prior to sending the filter-ready CMP waste slurry 207 to the filter 209.

From the second storage tank 203, the filter-ready CMP waste slurry 207 may be sent to the filter 209. The filter 209 may be, e.g., an ultrafilter or other device that both filters abrasive particles from the filter-ready CMP waste slurry 207 but also works to remove water from the filter-ready CMP waste slurry 207. As such, the filter 209 may have a single input to receive the filter-ready CMP waste slurry 207 and two outputs: one for the concentrated CMP slurry 205 that may be returned to the second storage tank 203 (discussed above) and one for permeate 211 (e.g., water) that has been removed from the filter-ready CMP waste slurry 207.

To achieve this combination of separations, the filter 209 may utilize a membrane which allows water to permeate through the membrane to form the permeate 211 while simultaneously capturing abrasive particles. One such membrane that may be used is an ultrafiltration membrane that can filter particles larger than about 0.1 μm from a permeate (e.g., permeate 211) while also discharging some of the filter-ready CMP waste slurry 207 as a concentrate (e.g., concentrated CMP slurry 205). This discharging of a portion of the filter-ready CMP waste slurry 207 helps to prevent clogging of the ultrafiltration membrane. The ultrafiltration membrane may be any suitable design, such as a tubular, capillary, or hollow-fiber module, and may have any suitable structure, such as a symmetrical or asymmetric structure.

To direct the filter-ready CMP waste slurry 207 to the filter 209, a second valve 206, a third valve 208, a fourth valve 210, and a fifth valve 221 are opened and a sixth valve 214 is closed. Once these valves are opened and closed, a second pump 212 that receives an influent from the second storage tank 203 may be started to pump the filter-ready CMP waste slurry 207 to the filter 209.

In operation, the filter 209 may process between about 180 and about 390 cubic meters per hour (CMH) of the filter-ready CMP waste slurry 207, such as about 300 CMH of the filter-ready CMP waste slurry 207. Of the filter-ready CMP waste slurry 207, the filter 209 may remove between about 18 CMH and about 39 CMH, such as about 30 CMH of the filter-ready CMP waste slurry as permeate 211 for a 1:10 cross-flow through the filter 209. The permeate may then be directed through the fifth valve 221 to a third storage tank 213, which, similar to the first storage tank 201 and the second storage tank 203, may be sized to accommodate the flow of permeate 211 (the third pump 219, the seventh valve 217, and the eighth valve 216 are discussed below with respect to FIG. 3). As such, the third storage tank may have a capacity of between about 100 cubic meters and about 200 cubic meters, such as about 150 cubic meters, so as to accommodate the flow of permeate 211 from the filter 209.

The remainder of the filter-ready CMP waste slurry 207 exits the filter 209 as the concentrated CMP slurry 205 and may have a flow rate of between about 180 CMH and about 360 CMH, such as about 270 CMH, for a 1:10 cross-flow through the filter 209. After the concentrated CMP slurry 205 has left the filter 209, the concentrated CMP slurry 205 may travel through the fourth valve 210 and be returned to the second storage tank 203, where it may be mixed with the CMP waste slurry 107 as described above.

During the operation of the filter 209, abrasive particles will accumulate within the filter 209 and cause the differential pressure through the filter 209 to increase. If allowed to go unchecked, the rise in differential pressure will eventually lead to a reduction in efficiency of the process as a whole. As such, the filter 209 needs to be periodically cleansed in order to remove the accumulated abrasive particles and restore the filter 209 back to an appropriate differential pressure.

To determine when such a cleansing process needs to be initiated, a pressure differential switch 218 may be located between an inlet of the filter 209 and the permeate 211 outlet of the filter 209. The pressure differential switch 218 may have pressure monitors (indicated in FIG. 2 by the dashed lines leaving the pressure differential switch 218) located on both the inlet line and the outlet line of the filter 209. These pressure monitors may monitor the pressure in each line either directly or indirectly (using, e.g., an indication of pressure such as height of a column of mercury) using such measuring devices as manometers, barometers, etc., and the pressure differential switch 218 may compare the separate pressures to determine if the pressure differential between them exceeds a certain threshold, such as greater than about 0.8 bars. Once the threshold is reached, then the cleansing operation above may be initiated.

Alternatively, as one of ordinary skill in the art will recognize, the pressure differential switch 218 may monitor the pressure differential or other indicator of pressure differential without monitoring and comparing the pressures in each of the lines. For example, a differential manometer may be used to determine the differential pressure between the lines without directly taking and comparing the actual pressures in the lines. Any form of determining the differential pressure between the filter's 209 inlet and permeate outlet may alternatively be utilized, and all such determinations are fully intended to be included within the scope of the present embodiments.

FIG. 3 illustrates one such cleaning process that may be initiated once the differential pressure reaches 0.8 bars, again with the direction of flows being highlighted by the arrows. This operation may be a backwash operation, which consists of flushing a cleaning material through the filter 209 in a direction that is counter to the normal operating direction of the filter 209. For example, the cleaning material may be introduced into what would during normal operation be the outlet for the permeate 211 from the filter 209, thereby causing the cleaning material to travel backwards through the filter 209, dislodging the accumulated abrasive particles, and cleaning the filter 209.

For example, in an embodiment a portion of the permeate 211 stored in the third storage tank 213 may be utilized as the cleaning material. In such an embodiment, the permeate 211 may be run through the filter 209 in a counter flow path by introducing the permeate 211 into the normal outlet of the filter 209 for the permeate 211, thereby flushing the filter 209 of the accumulated waste material. This backwash operation may be performed by closing the third valve 208, the fourth valve 210 and the fifth valve 221 while opening the sixth valve 214, a seventh valve 215, and an eight valve 216. Once these valves have been opened and closed as indicated, a third pump 219 may be initiated to pump the permeate 211 from the third storage tank 213 back through the filter 209 in order to flush the filter 209.

The backwash operation may occur for between about 30 minutes and about 50 minutes, such as about 40 minutes at a flow rate of between about 80 CMH and about 100 CMH, such as about 90 CMH. This cleaning process will create the concentrated CMP waste slurry 111 which may have an abrasive concentration of between about 3% and about 6%, resulting in a concentration that is ten times greater than the initial concentration of the CMP waste slurry 107 that enters the concentration unit 109. The concentrated CMP waste slurry 111, after traveling through the open sixth valve 214, may be stored in the holding tank 117.

The holding tank 117 may be appropriately sized in order to accommodate the flow of the concentrated CMP waste slurry 111 and storing it until it can be shipped. As such, in an embodiment where the flow rate of concentrated CMP waste slurry 111 is between about 18 CMH and about 39 CMH, such as about 30 CMH, the size of the holding tank 117 may be between about 50 cubic meters and about 70 cubic meters, such as about 60 cubic meters. From the holding tank 117, the concentrated CMP waste slurry 111 may be prepared and sent off site as described above with respect to FIG. 1.

Additionally, while a portion of the permeate 211 in the third storage tank 213 may be used in the backwash operation, the remainder of the permeate 211 may be sent from the third storage tank 213 to the wastewater treatment facility 115. For example, if 30 CMH of permeate 211 is utilized in the backwash operation as described above, the remainder of the permeate, or about 20 CMH, may be removed from the concentration unit by sending it from the third storage tank 213 to the wastewater treatment facility (as described above with respect to FIG. 1). This permeate 211 may then be reused, recycled, or otherwise disposed by the proper facilities.

The parameters utilized to initiate and operate the cleansing operation are critically important to the proper functioning and capacity of the concentration unit 109. For example, due to the backflow operation, the overall process of concentrating the CMP waste slurry 107 is not a continuous process, as the filtering must be stopped in order to perform the cleansing process. Given this, by using the trigger of 0.8 bar (instead of a trigger of, e.g., 0.6 bar that other processes may utilize), more time may be spent filtering while also getting a larger concentration. As such, by using the trigger of 0.8 bar, the overall capacity of the concentration unit 109 can be doubled over using other triggers such as 0.6 bar.

Additionally, the amount of concentration that the concentration unit 109 can perform is also dependent upon the parameters used to initiate the cleansing process (e.g., the backwash operation). For example, while some operations may use a differential pressure trigger of 0.6 bar with a cross flow rate of 1:6, this low trigger will also result in a low concentration (as there will be less accumulated abrasives in the filter to wash out), such as about 0.4 bar. However, by utilizing a trigger of about 0.8 bars and a cross-flow rate of 1:10, more abrasives will be accumulated in the filter, resulting in a stream that has a much higher concentration of abrasives, and in a concentration that is ten times higher than the CMP waste slurry 107 that enters the concentration unit 109. As such, the precise trigger is critical to achieving the desired levels of concentration without requiring new capital equipment.

Finally, by concentrating the CMP waste slurry 107 to such a high concentration, the overall costs for recycling the CMP waste slurry 107 can also be reduced. As most recycling costs are determined by the volume amount of waste that is shipped, the more the CMP waste slurry can be concentrated, the more its overall volume can be reduced, and the lower the costs associated with recycling the CMP waste slurry 107. As such, by utilizing the trigger of 0.8 bars, the costs of recycling the CMP waste slurry 107 can also be reduced without further capital expenditures.

FIG. 4 illustrates an alternative embodiment of the filter 209, in which multiple filters 209 are arranged in parallel to each other, with each of the multiple filters receiving filter-ready CMP waste 207 and each having an exit for permeate 211 and an exit for concentrated CMP slurry 205. By utilizing a parallel arrangement of multiple filters 209, some of the filters (e.g., the two left-most filters 209 in FIG. 4) can be utilized in the filtering process (described above with respect to FIG. 2) while other filters (e.g., the two right-most filters 209 in FIG. 4) are in the cleansing process (described above with respect to FIG. 3). By allowing using some of the filters 209 to continue to filter the filter-ready CMP waste slurry 207 while allowing other filters 209 to be in a cleansing operation, the entire process may be continuous, instead of having to continually interrupt the filtering process for the cleansing process.

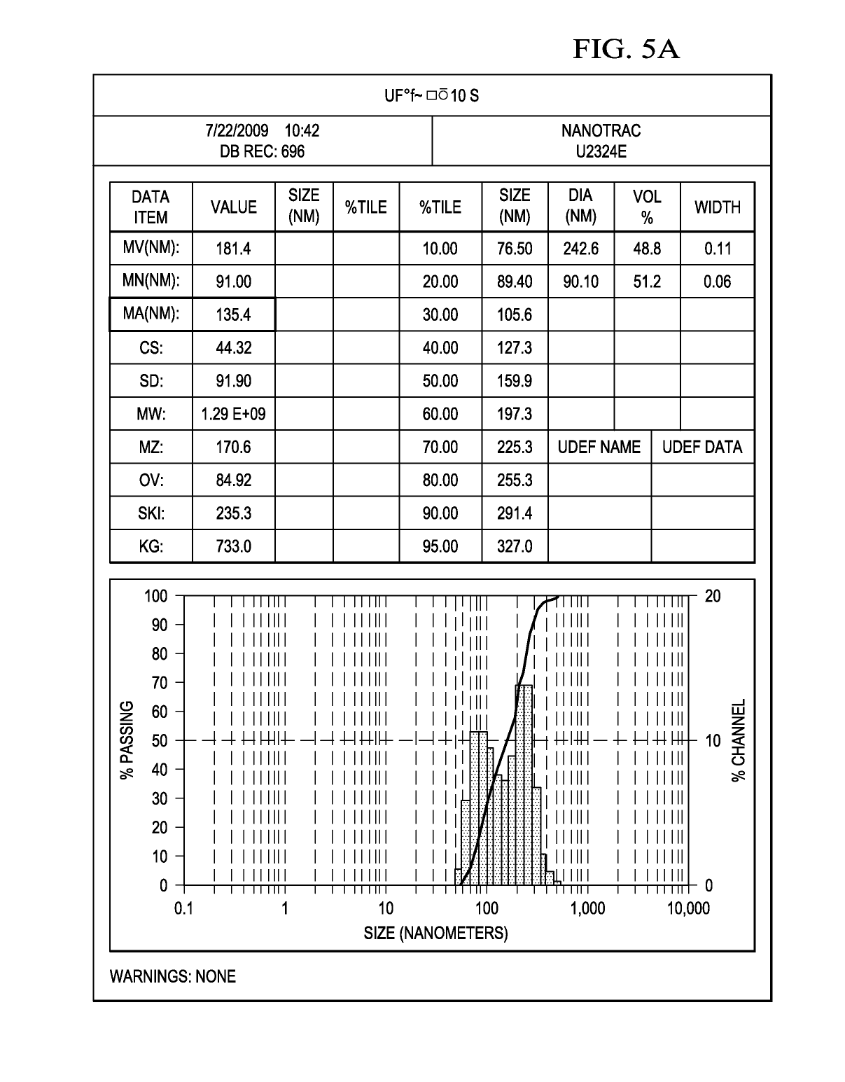

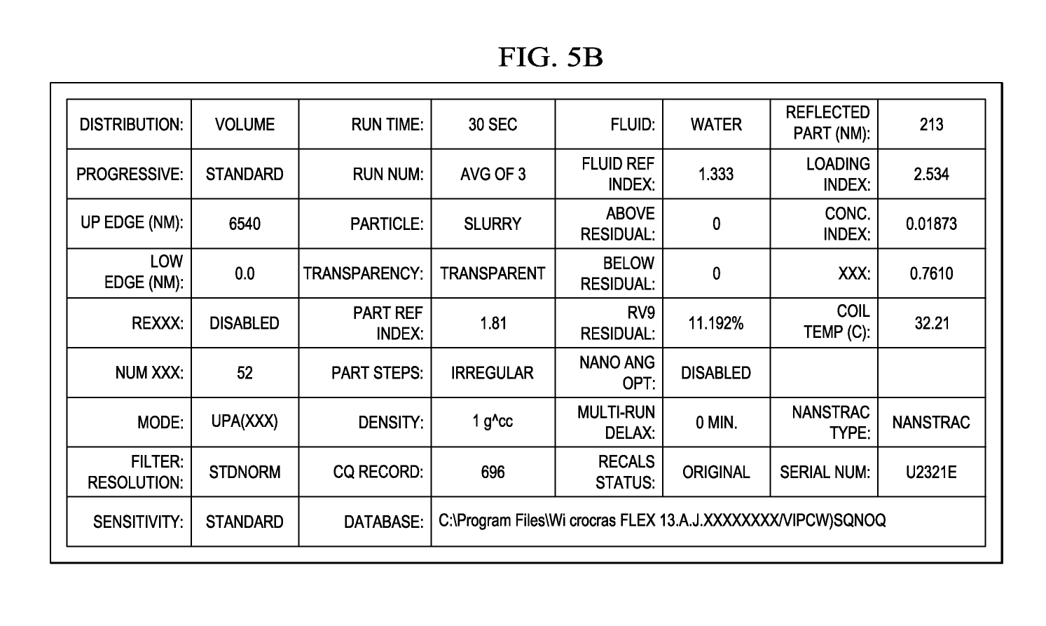

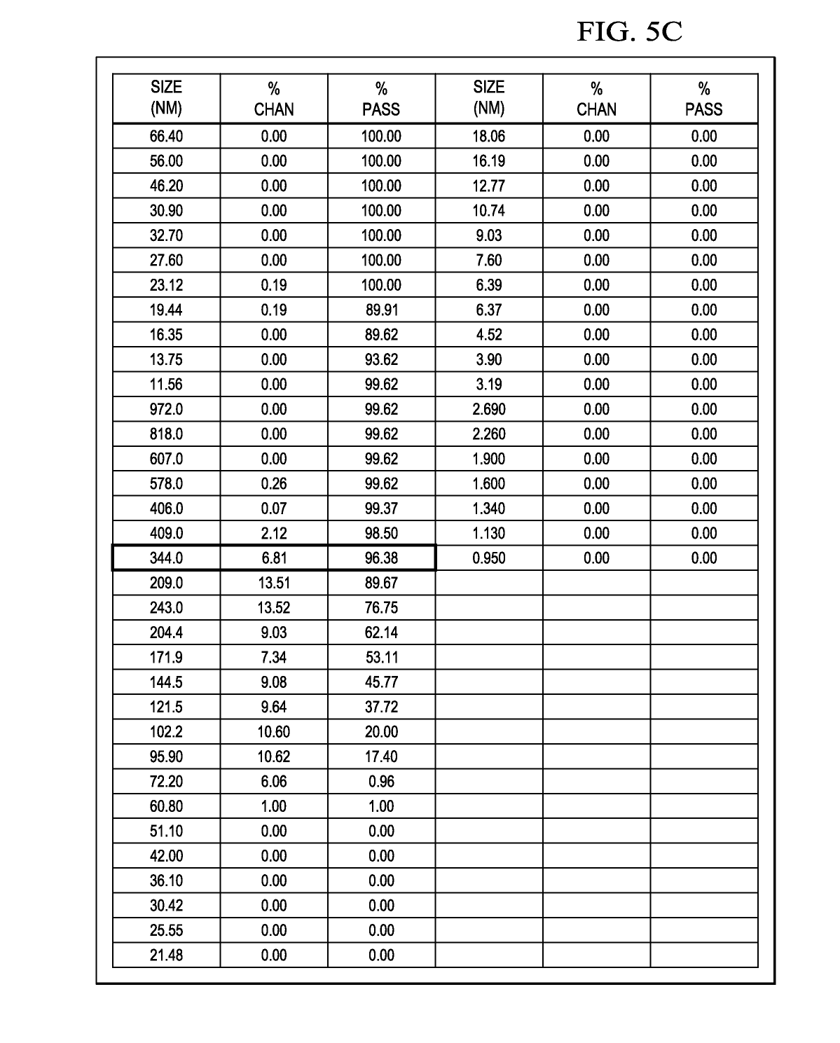

FIG. 5 illustrates the results that can occur by using the concentration unit 109 as described above. As illustrated, an analysis of the concentrated CMP waste slurry 211 shows that it may have a particle size distribution of more than 96% under 344 nm. Further, the average particle size is about 135 nm, with a mean volume diameter of between 133 nm and 152 nm and a maximum diameter of less than 343 nm. These results are fully consistent with recycling standard for CMP waste slurry.

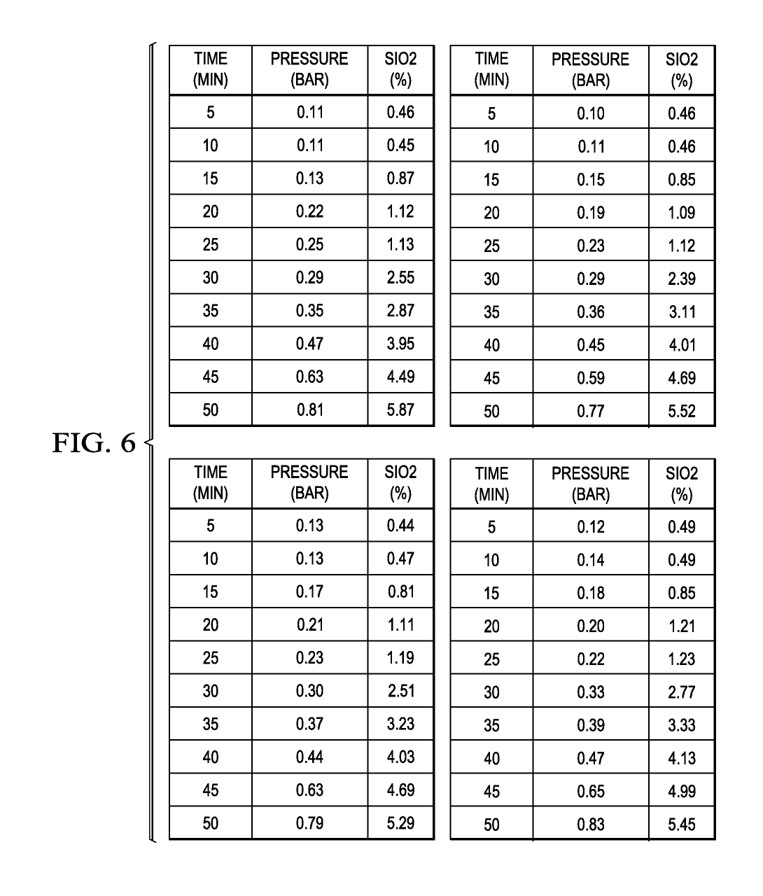

FIG. 6 illustrates four separate runs wherein the silica content was analyzed based upon the pressure used to trigger the cleansing operation. As shown in each of the four test results, the silica/abrasive content when the filter 209 is backwashed at 0.8 bar is much higher than if the backwash is triggered at a lower pressure. As such, the trigger of 0.8 bar is critical to the efficient operation of the concentration unit 109.

In accordance with an embodiment, a method for concentrating a slurry comprising filtering the slurry through a filter is provided. The filtering generates a concentrate and a permeate. A backwash operation is performed on the filter using a portion of the permeate, the backwash operation occurring after a pressure differential between an inlet of the filter and a permeate outlet of the filter is greater than 0.8 bar.

In accordance with an other embodiment, a method for recycling a slurry is provided. The method comprises receiving the slurry and mixing the slurry with an outlet slurry from a filter, the mixing forming a separation-ready slurry. Water is separated from the separation-ready slurry, the separating water forming the outlet slurry and a permeate. A backwash operation is performed with at least a portion of the permeate, the backwash operation occurring upon a pressure differential of 0.8 bar between a first line transporting the permeate and a second line transporting the separation-ready slurry.

In accordance with yet another embodiment, a concentration unit comprising a filter with an inlet, a concentrated outlet, and a permeate outlet is provided. The filter has a first flow of operation from the inlet to the permeate outlet. A first tank is connected to receive permeate from the filter through the permeate outlet in a first operating condition and also connected to provide permeate to the filter through the permeate outlet in a second operation condition. A pressure differential switch is connected to both the permeate outlet and the inlet, the pressure differential switch operative to switch from the first operating condition to the second operating condition if a differential pressure is greater than 0.8 bar.

Although the present embodiments and their advantages have been described in detail, it should be understood that various changes, substitutions and alterations can be made herein without departing from the spirit and scope of the embodiments as defined by the appended claims. For example, different cleaning materials may be used to flush the filter, and different flow rates may be utilized to process the CMP waste slurry.

Moreover, the scope of the present application is not intended to be limited to the particular embodiments of the process, machine, manufacture, composition of matter, means, methods and steps described in the specification. As one of ordinary skill in the art will readily appreciate from the disclosure of the present embodiments, processes, machines, manufacture, compositions of matter, means, methods, or steps, presently existing or later to be developed, that perform substantially the same function or achieve substantially the same result as the corresponding embodiments described herein may be utilized according to the present embodiments. Accordingly, the appended claims are intended to include within their scope such processes, machines, manufacture, compositions of matter, means, methods, or steps.

What is claimed is:

1. A method for concentrating a slurry, the method comprising:
filtering the slurry through a filter, the filtering generating a concentrate and a permeate; and
performing a backwash operation on the filter using a portion of the permeate, the backwash operation occurring after a pressure differential between an inlet of the filter and a permeate outlet of the filter is greater than 0.8 bar.

2. The method of claim 1, wherein the filter is a membrane filter.

3. The method of claim 1, wherein the permeate has a pH between about 7 and about 10 during the backwash operation.

4. The method of claim 1, wherein the filter further comprises a plurality of filtering units in parallel with each other.

5. The method of claim 1, further comprising:
receiving a CMP waste slurry; and
mixing the CMP waste slurry with the concentrate to form the slurry.

6. The method of claim 5, wherein the backwash operation generates a concentrated slurry that has an abrasive concentration ten times greater than the CMP waste slurry.

7. The method of claim 1, wherein the filter has a cross-flow of about 1:10 between the slurry and the concentrate.

8. The method of claim 1, wherein the backwash operation generates a concentrated slurry that is greater than ten times more concentrated than a CMP waste slurry.

9. The method of claim 1, further comprising:
monitoring a first indication of pressure at the inlet;
monitoring a second indication of pressure at the outlet; and
comparing the first indication of pressure and the second indication of pressure.

10. A method for recycling a slurry, the method comprising:
receiving a slurry;
mixing the slurry with an outlet slurry from a filter, the mixing forming a separation-ready slurry;
separating water from the separation-ready slurry, the separating water forming the outlet slurry and a permeate; and
performing a backwash operation with at least a portion of the permeate, the backwash operation occurring upon a pressure differential of 0.8 bar between a first line transporting the permeate and a second line transporting the separation-ready slurry.

11. The method of claim 10, further comprising:
measuring a first indication of pressure from the first line;
measuring a second indication of pressure from the second line; and
comparing the first indication of pressure and the second indication of pressure.

12. The method of claim 10, wherein the permeate is greater than 90% of the flow of the separation-ready slurry.

13. The method of claim 10, wherein the backwash operation generates a concentrated slurry, the concentrated slurry having at least 3% by volume of an abrasive.

14. The method of claim 13, wherein the water has a pH of between about 7 and about 10 during the backwash operation.

15. The method of claim 10, wherein the backwash operation generates a concentrated slurry, the concentrated slurry being at least ten times more concentrated than the slurry.

16. The method of claim 10, wherein the separating water is performed at least in part using an ultrafilter.

17. A concentration unit comprising:
a filter with an inlet, a concentrated outlet, and a permeate outlet, the filter having a first flow of operation from the inlet to the permeate outlet;
a first tank connected to receive permeate from the filter through the permeate outlet in a first operating condition and also connected to provide permeate to the filter through the permeate outlet in a second operating condition; and
a pressure differential switch connected to both the permeate outlet and the inlet, the pressure differential switch operative to switch from the first operating condition to the second operating condition if a differential pressure is greater than 0.8 bar.

18. The concentration unit of claim 17, further comprising an effluent from the first tank to remove permeate from the concentration unit.

19. The concentration unit of claim 17, further comprising a second tank connected to receive concentrate from the concentrated outlet and mix the concentrate with a slurry.

20. The concentration unit of claim 17, wherein the filter is an ultrafilter.
